(19) United States
(12) Patent Application Publication
(10) Pub. No.: US 2015/0310862 A1
(43) Pub. Date: Oct. 29, 2015

(54) DEEP LEARNING FOR SEMANTIC PARSING INCLUDING SEMANTIC UTTERANCE CLASSIFICATION

(71) Applicant: Microsoft Corporation, Redmond, WA (US)

(72) Inventors: Yann Nicolas Dauphin, Montreal (CA); Dilek Z. Hakkani-Tur, Los Altos, CA (US); Gokhan Tur, Los Altos, CA (US); Larry Paul Heck, Los Altos, CA (US)

(73) Assignee: Microsoft Corporation, Redmond, WA (US)

(21) Appl. No.: 14/260,419

(22) Filed: Apr. 24, 2014

(51) Int. Cl. G10L 15/18; G06F 17/27; G10L 15/26

(52) U.S. Cl. CPC G10L 15/1815; G10L 15/26; G06F 17/2705

(57) ABSTRACT

One or more aspects of the subject disclosure are directed towards performing a semantic parsing task, such as classifying text corresponding to a spoken utterance into a class. Feature data representative of input data is provided to a semantic parsing mechanism that uses a deep model trained at least in part via unsupervised learning using unlabeled data. For example, if used in a classification task, a classifier may use an associated deep neural network that is trained to have an embeddings layer corresponding to at least one of words, phrases, or sentences. The layers are learned from unlabeled data, such as query click log data.

### BACKGROUND

Conversational machine understanding systems aim to automatically classify a spoken user utterance into one of a set of predefined semantic categories and extract related arguments using semantic classifiers. In general, these systems, such as used in smartphones' personal assistants and the like, do not place any constraints on what the user can say.

As a result, semantic classifiers need to allow for significant variations in utterances, whereby automatic utterance classification is a complex problem. For example, one user may say “I want to fly from San Francisco to New York next Sunday” while another user may express basically the same information by saying “Show me weekend flights between JFK and SFO.” Although there is significant variation in the way these commands are expressed, a good semantic classifier needs to classify both commands into the same semantic category, such as “Flights.”

At the same time, spoken expressions that are somewhat close to one another may not be in the same category, and thus semantic classifiers need to allow for even slight variations in utterances. For example, the command “Show me the weekend snow forecast” needs to be interpreted as an instance of another semantic class, such as “Weather,” and thus needs to be properly distinguished from “Show me weekend flights between JFK and SFO.”

Semantic utterance classification systems estimate conditional probabilities based upon supervised classification methods trained with labeled utterances. Traditional semantic utterance classification systems require large amounts of manually labeled training data, which is costly and difficult to update, such as when a new category is desired.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, one or more of various aspects of the subject matter described herein are directed towards performing a semantic parsing task, including providing feature data representative of input data to a semantic parsing mechanism, in which a model used by the semantic parsing mechanism comprises a deep model trained at least in part via unsupervised learning using unlabeled data. Output received from the semantic parsing mechanism corresponds to a result of performing the semantic parsing task.

One or more aspects may include a classifier and associated deep network, in which the deep network is trained to have an embeddings layer corresponding to at least one of words, phrases, or sentences. The embeddings layer is learned (at least in part) from unlabeled data. The classifier is coupled to a feature extraction mechanism to receive feature data representative of input text from the feature extraction mechanism, with the classifier configured to classify the input text as a result set comprising classification data. A speech recognizer may be used to convert an input utterance into the input text that is classified.

One or more storage media or machine logic have executable instructions, which when executed classify textual input data into a class, including determining feature data representative of the textual input data, and providing the feature data to a classifier. A model used by the classifier comprises a deep network trained at least in part on unlabeled data. A result set comprising a semantic class is received from the classifier.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example environment for offline training of a semantic parsing mechanism for later online use in performing a semantic parsing task, according to one or more example implementations.

FIG. 2 is a representation of generating embeddings for a deep network based upon training with query, Uniform Resource Locator (URL) clicks, according to one or more example implementations.

FIG. 3 is a representation of a deep network used as a model for a semantic parsing task, exemplified as a text classification task, including an embeddings layer and classification layer, according to one or more example implementations.

FIG. 4 is a flow diagram showing example steps that may be used to train a deep model using unsupervised training with unlabeled data in the form of query URL log data, according to one or more example implementations.

FIG. 5 is a flow diagram showing example steps that may be used to perform a semantic parsing text using a deep model, exemplified as a text classification process, according to one or more example implementations.

FIGS. 6 and 7 are block diagrams representing exemplary non-limiting computing systems/devices/machines/operating environments in which one or more aspects of various embodiments described herein, including deep model training and usage, can be implemented.

### DETAILED DESCRIPTION

Various aspects of the technology described herein are generally directed towards performing a semantic parsing task such as spoken utterance classification using a deep model trained with unlabeled data, where in general, “deep” refers to a multiple layer model/model learning technique. As will be understood, regardless of the input data, there are latent semantic features (e.g., the words and the number of words, i.e., sentence length) that are extracted and provided to the trained model to perform the semantic parsing task. For example, even if there is no training data for a sentence such as “wake me up at 6:00 am,” the trained model may be used to determine the similarity between the feature data extracted from the sentence with the feature data trained into the model. In one or more implementations, the model comprises a deep neural network that may be used by a classifier for semantic utterance classification in a conversational understanding system.

In one aspect, labeled training data need not be used in training the deep model; rather, the deep networks may be trained with large amounts of implicitly annotated data. In one or more implementations, the deep networks are trained using web search query click logs, which relate user queries to associated clicked URLs (Uniform Resource Locators). In general, clicked URLs tend to reflect high level meanings/intent of their associated queries. Words and/or phrases in an embeddings (topmost hidden) layer of the deep network are learned from the unlabeled data.

As will be understood, the deep networks are trained to obtain unstructured text embeddings. These embeddings provide the basis for zero-shot semantic learning (in which the classification result need not be in the training set), and zero-shot discriminative embedding as described herein. In practice, zero-shot discriminative embeddings used as features in semantic utterance classification have been found to have a lower error rate relative to prior semantic utterance classification systems.

It should be understood that any of the examples herein are non-limiting. For example, classification of an utterance is primarily used as an example semantic parsing task herein, however other semantic parsing tasks may benefit from the technology described herein. Non-limiting examples of such tasks that may use latent semantic information with such a trained model include language translation tasks, understanding machine recognized input, knowledge base population or other extraction tasks, semantic template filling, and other similar semantic parsing tasks. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and data processing in general.

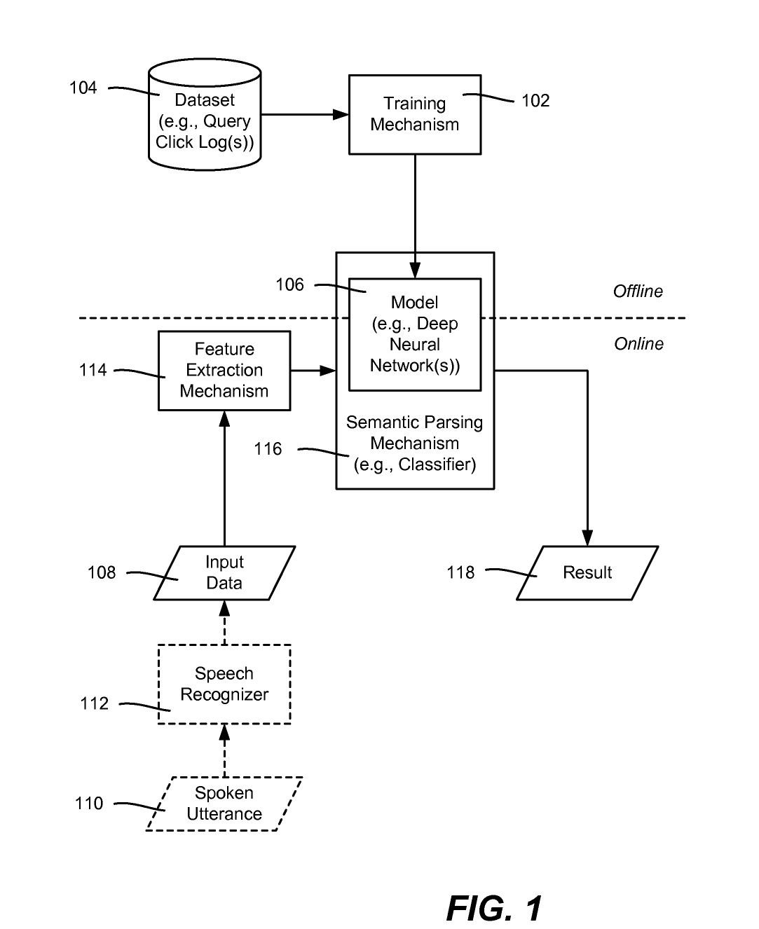

FIG. 1 shows a general block diagram of an example implementation in which a training mechanism 102 uses unlabeled training data from a dataset 104 such as in the form of query click logs or the like (e.g., search logs, a knowledge base/graph) to train a model 106, comprising a deep neural networks model in one or more implementations. For example, the training mechanism 102 is based upon any suitable technology that uses a deep learning architecture to extract latent semantic features, e.g., for spoken utterance classification. Typically the training is performed in an offline stage; for example, a suitable training set may use on the order of ten million queries with a vocabulary of one-hundred thousand words and one-thousand base URLs. In general, each query word or phrase corresponds to a URL click rate distribution, with the rate distribution used as continuous valued features by the classifier or the like. Training may be general for one application, or at a finer granularity for another, such as per domain, e.g., using query click log URLs from the “entertainment” domain such as television shows, movies and so on. The vocabulary and base URLs may be selected for such more specific domains.

In online usage, input data 108 is received in the form of text, which may come from an utterance 110 recognized by a recognizer 112 as text. The input data 108 may comprise a single word or any practical number of words, from which feature data are extracted (block 114) and input to a semantic parsing mechanism 116 (e.g., including a classifier/classification algorithm) that uses the trained model 106. Example types of classifiers/classification algorithms include Boosting, support vector machines (SVMs), or maximum entropy models.

Based upon the trained model 106, the semantic parsing mechanism 116 outputs a result 118, such as a class (or an identifier/label thereof) to which a speech utterance most likely belongs. Note that instead of a single result such as a class, in alternative embodiments it is straightforward for the semantic parsing mechanism 116 to return result set comprising a list of one or more results, e.g., with probability or other associated data with each result. For example, if the two highest probabilities for two classes are close to one another and each returned with its respective probability data, a personal assistant application may ask the user for further clarification from the user rather than simply select the class associated with the highest probability. Other types of results are feasible, e.g., Yes or No as to whether the input data is related to a particular class according to some probability threshold.

In general, a semantic utterance classification task aims at classifying a given speech utterance Xᵣ into one of M semantic classes, ĈᵣεC={C₁, . . . , Cₘ} (where r is the utterance index). Upon the observation of Xᵣ, the class Ĉᵣ is chosen so that the class-posterior probability given Xᵣ, P(Cᵣ|Xᵣ), is maximized. More formally,

$${\hat{C}}_{r} = {arg max }_{Cr} P ( {C}_{r} \text{\textbar} {X}_{r} ) \qquad ( 1 )$$

As described herein, the classifier is feature based. In order to perform desirable classification, the selection of the feature functions ƒᵢ (C,W) aims at capturing the relation between the class C and word sequence W. Typically, binary or weighted n-gram features (with n=1, 2, 3, to capture the likelihood of the n-grams) are generated to express the user intent for the semantic class C. Once the features are extracted from the text, the task becomes a text classification problem. Traditional text categorization techniques devise learning methods to maximize the probability of Cᵣ, given the text Wᵣ; i.e., the class-posterior probability P(Cᵣ|Wᵣ).

Traditional semantic utterance classification systems rely on a large set of labeled examples (Xᵣ, Cᵣ) to learn a good classifier ƒ. Traditional systems thus suffer from bootstrapping issues and make scaling to a large number of classes costly, among other drawbacks. Described herein is solving the problem of learning ƒ with unlabeled examples Xᵣ, which in one or more implementations comprise query-click logs; this is a form of zero-shot learning. Query click logs are logs of unstructured text including users' queries sent to a search engine and the links on which the users clicked from the list of sites returned by that search engine. A common representation of such data is a bi-partite query-click graph, where one set of nodes represents queries and the other set of nodes represents URLs, with an edge placed between two nodes representing a query q and a URL u if at least one user who submitted q clicked on u. Traditionally, the edge of the click graph is weighted based on the raw click frequency (number of clicks) from a query to a URL.

Semantic utterance classification is based upon an underlying semantic connection between utterances and classes. The utterances that belonging to a class share some form of similarity to each other. In contrast to labeled data training, as described herein, much of the semantics of language can be discovered without labeled data. Moreover, the names of semantic classes are not chosen randomly, but rather they are often chosen because they describe the essence of the class. These two facts can be used easily by humans to classify without task-specific labels; e.g., it is easy for humans to determine that the utterance “the particle has exploded” belongs more to the class “physics” than a class “outdoors.” This human ability is replicated to an extent as described herein.

In one alternative, described herein is a framework called zero-shot semantic learning, in which given a sentence and a class as input data, a similarity to the class is provided, (e.g., what is the probability that this input [some sentence] is related to the class “flight” or to ask whether this input [some sentence] is closer to the “flight” class or the “restaurant” class. Zero-shot semantic learning learns to perform semantic utterance classification with only a set of unlabeled examples X={X₁ . . . , Xₙ} and the set of class names C={C₁ . . . , Cₘ}. Furthermore, the names of the classes belong to the same language as the input set X. This framework has the form:

$$P ( {C}_{r} \text{\textbar} {X}_{r} ) = \frac{1}{2} {e}^{- {‖ P ( H \text{\textbar} {X}_{r} ) - P ( H \text{\textbar} {C}_{r} ) ‖}^{2} } where \\ Z = {\sum }_{c} {e}^{- {‖ P ( H \text{\textbar} {X}_{r} ) - P ( H \text{\textbar} C ) ‖}^{2}} . \qquad ( 2 )$$

P(H|X) is a probability distribution over different meanings of the input X, and is used to recover the meaning of the utterance Xᵣ. The distribution of meanings according to a class P(H|Cᵣ) is given by the distribution of meanings of the class name. For example, given a class Cᵣ with the name “physics” the distribution is found by using the class name as an utterance P(H|Cᵣ)=p(H|X={physics}). Equation (2) finds the class name which has the closest semantic meaning to the utterance. This framework will classify properly if (a) the semantics of the input are properly captured by P(H|X), i.e., utterances are clustered according to their meaning, and (b) the class name Cᵣ describes the semantic core of the class reasonably well. The “best” class name has a meaning P(H|Cᵣ), i.e., the mean for its utterances E_{X}_{ᵣ}_{|C}_{ᵣ}[P(H|Xᵣ)].

Most of the computation in this framework is performed by P(H|X), which operates to put related utterances close in the latent space. There are a wide array of models that can provide p(H|X). This includes latent semantic analysis, principal component analysis, and other well known unsupervised learning algorithms. Described herein is using deep learning to obtain the latent meaning representation. In this context, the system is directed to learning an embedding, which is able to disentangle factors of variations in the meaning of a document.

Embeddings may be obtained by training deep neural networks using the query click logs. In general, the hypothesis is that the website clicked following a query reveals the meaning or intent behind a query, that is, the queries that have similar meaning or intent will tend to map to the same website. For example, queries associated with the website imdb.com share a semantic connection to movies.

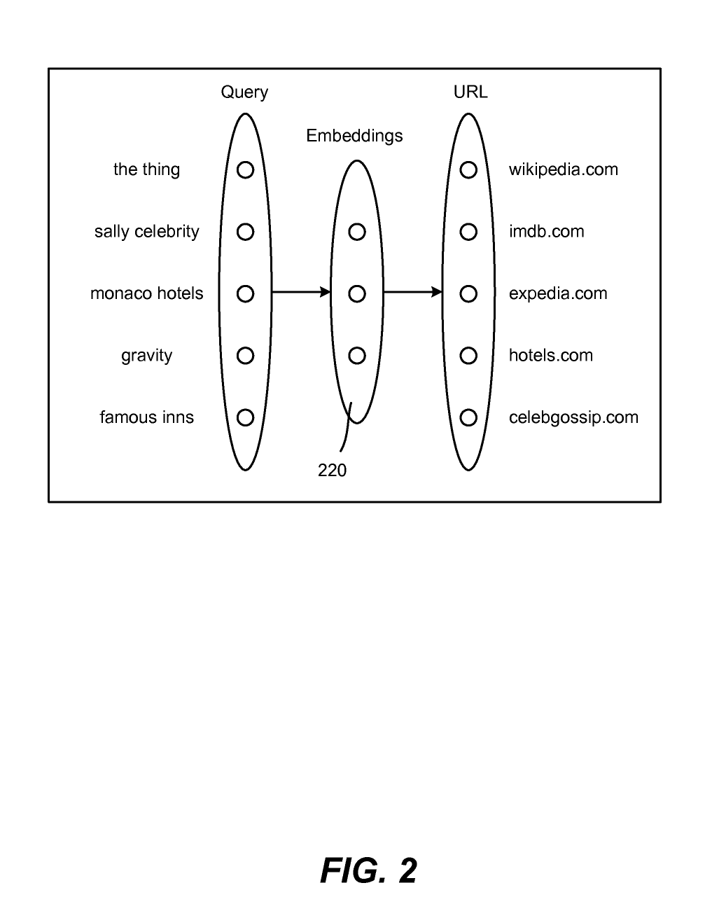

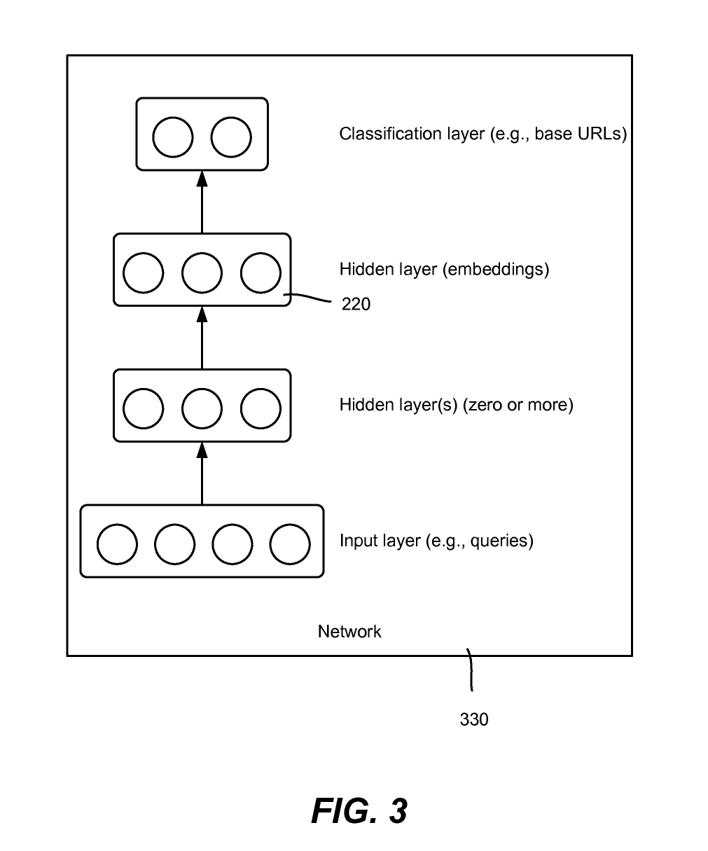

The network is trained with the query as input and the website as the output (FIG. 2), with embeddings 220 in a hidden layer. In general, the last hidden layer, shown as the embeddings 220 of the network 330 (FIG. 3), learns an embedding space that is helpful to classification; in order to do this, it maps similar inputs in terms of the classification task that are close in the embedding space.

In one or more implementations, deep neural networks are trained with softmax output units on base URLs and rectified linear hidden units. In one or more implementations, the inputs Xᵣ are queries represented in bag-of-words format. The labels Yᵣ are the index of the website that was clicked. The network is trained to minimize the negative log-likelihood of the data

L(X,Y)=−log P(Yᵣ|Xᵣ).

The network has the form

$$P ( Y = i \text{\textbar} {X}_{r} ) = \frac{{e}^{{W}_{i}^{n + 1} {H}^{n} ( {X}_{r} ) + {b}_{i}^{n + 1}}}{{\sum }_{j} {e}^{{W}_{j}^{n + 1} {H}^{n} ( {X}_{r} ) + {b}_{j}^{n + 1}}}$$

The latent representation function Hⁿ is composed on n hidden layers

Hⁿ(Xᵣ)=max(0,WⁿHⁿ⁻¹(Xᵣ)+bⁿ)

H¹(Xᵣ)=max(0,W¹Xᵣ+b¹)

There is a set of weight matrices W and biases b for each layer, giving the parameters θ={W¹, b¹, . . . , Wⁿ⁺¹, bⁿ⁺¹} for the full network. Note that although rectified linear units are not smooth, research has shown that they can greatly improve the speed of learning of the network. In one or more implementations, the network is trained using stochastic gradient descent with mini-batches. The meaning representation P(H|X) is found at the last embedding layer Hⁿ(Xᵣ). The optimal number of layers to use is not known in advance and is found through cross-validation with a validation set, e.g., the number of layers is between one and three and the number of hidden units is kept constant through layers, and may be found by sampling a random number from 300 to 800 units.

Described above is a way to use unlabeled examples to perform zero-shot semantic utterance classification. The embeddings described may be additionally useful and it is known that using unsupervised learning algorithms like the restricted Boltzmann machine can help leverage this additional data. These unsupervised algorithms can be used to initialize the parameters of a deep neural network and/or to extract features/embeddings. Effectively, these methods replace the task of learning P(C|X) to learning a density model of the data P(X). The hypothesis is that P(C|X) shares structure with P(X). Thus, the features learned from P(X) are useful to model P(C|X). In other words, it can be assumed that learning features from P(X) is a good proxy to learn features for P(Y|X).

Described herein is a reasoned proxy task to learn features for semantic utterance classification, which may be considered zero-shot discriminative embedding. Consider that the quality of a proxy \hat{ƒ} for a function ƒ is measured by the error E_{X}[∥ƒ(X)−\hat{ƒ}(X)∥²]; a good proxy should have a small error. It may be readily appreciated that gradient-based learning with ƒ approximates learning with ƒ, which is why bootstrapping a classifier with the objective \hat{ƒ} may be useful.

This framework imposes several restrictions over the function ƒ, including that if ƒ:X→Y then \hat{ƒ}:X→Y. The proxy needs to be defined over the same input and output space. The restriction over the input space is easy to satisfy by the various known pre-training methods like restricted Boltzmann machines and regularized auto-encoders. The restriction over the output is not satisfied by these methods and thus they cannot be measured as proxies under this definition.

In general, finding a function satisfying these restrictions is difficult, but the building blocks for such a function are described above in the context of semantic utterance classification. Zero-shot semantic learning can be used to define a good proxy task. In practice, the classification results with zero-shot semantic learning are good whereby the error E_{X}[∥ƒ(X)−\hat{ƒ}(X)∥²] is relatively small.

As described above, zero-shot semantic learning relies on learning embeddings on the query click logs that cluster together utterances that have the same meaning. These embeddings do not have any pressure to cluster according to the semantic utterance classification classes. A goal is to have these embeddings cluster not only according to meaning, but also to cluster according to the final semantic utterance classification classes. In order to do this zero-shot semantic learning is used as a proxy to quantify the quality of a clustering over classes. One possibility is to maximize the likelihood P(Cᵣ|Xᵣ) of zero-shot semantic learning directly, but this requires labeled data. Instead this quality measure is defined as the entropy over the predicted semantic classes

$$\begin{matrix}H ( P ( {C}_{r} \text{\textbar} {X}_{r} ) ) = E [ I ( P ( {C}_{r} \text{\textbar} {X}_{r} ) ) ] \\ = E [ - {\sum }_{i}^{ } P ( {C}_{r} = i \text{\textbar} {X}_{r} ) log P ( {C}_{r} = i \text{\textbar} {X}_{r} ) ] .\end{matrix} \qquad ( 3 )$$

The entropy represents the uncertainty over the class. The more certain over the class, the better the clustering given by the embedding P(H|X). The better the proxy function \hat{ƒ} the better this measure a (∥H(ƒ(X))−H(\hat{ƒ}(X))∥²≦K∥ƒ(X)−\hat{ƒ}(X)∥² by Lipschitz continuity). Another property is that this measure marginalizes over possible classes and so does not require labeled data. Zero-shot discriminative embedding leverages this measure to learn an embedding that clusters according to the semantic classes without any labeled data. It relies on jointly learning an embedding space by predicting the clicks and optimizing the clustering measure given by Equation (3). The objective has the form:

L(X,Y)=−log P(Y|X)+λH(P(C|X)). (4)

The variable X is the input, Y is the website that was clicked, and C is a semantic class. The functions log P(Y|X) and log P(C|X) are predicted by a deep neural network as described herein. Both functions use the same embedding provided by the last hidden layer of the network. The term H(P(C|X)) can be thought of as a regularization that encourages the embedding to cluster according to the classes. It is a force in the embedding space that makes the examples congregate around the position of class names in the embedding space. The hyper-parameter λ controls the strength of that force in the overall objective; its value may be found by cross-validation, e.g., the hyper-parameters of the models are tuned on the validation set and the learning rate parameter of gradient descent may be found by grid search with {0.1, 0.01, 0.001}.

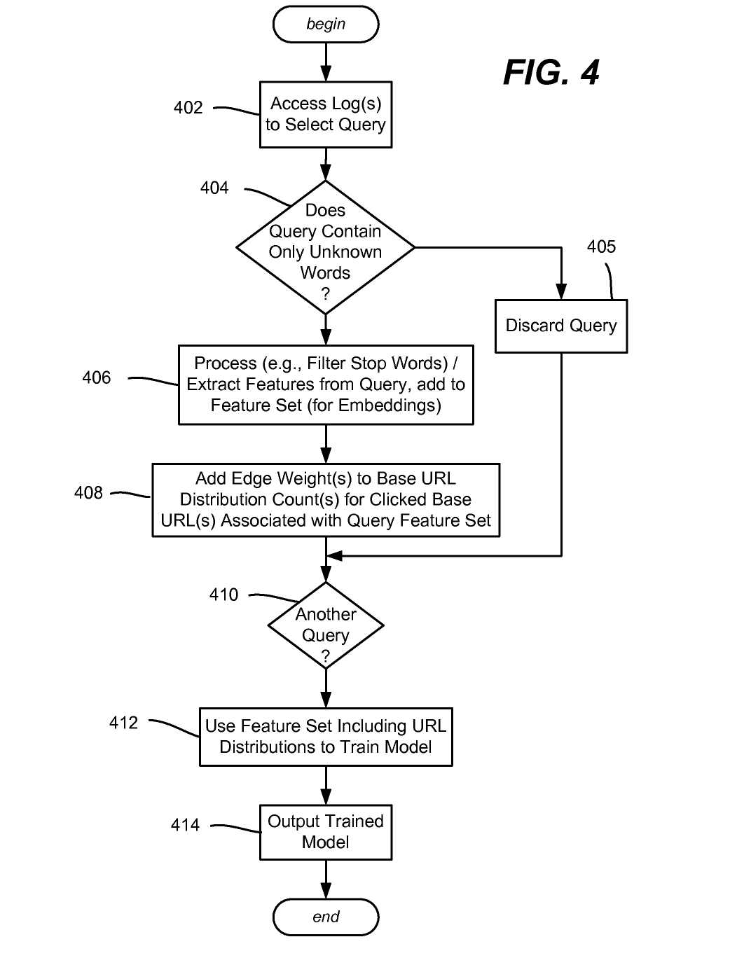

FIG. 4 is a flow diagram summarizing some example steps that may be used in feature-based model training, which in this example uses a query click log as the unlabeled data. At step 402, the query click log is accessed to select a query. Steps 404 and 405 filter out queries that do not have any words in the selected vocabulary, (if one is used). Step 406 processes the query to extract features therefrom, which may include removing stop words such as “a” or “the” as well as any other desired preprocessing operations (e.g., correcting misspellings, removing words not in the vocabulary, and so on). Note that instead of filtering per query as exemplified in FIG. 4, a filtering preprocess may be used to filter/prepare a dataset as desired before any feature extraction, for example.

Step 408 adds the edge weight (indicative of the number of clicks for that particular query assuming a query click graph is used) for each clicked base URL to the distribution count, which are used as continuous features. Note that a query that does not map to at least one base URL may be discarded in a filtering operation before step 408.

Step 410 repeats the process until the feature data for the query words, phrases and/or sentences have been extracted and the URL distribution is known. When no more queries remain, step 412 trains the model using the feature set, including the query features and the URL distributions. Step 414 outputs the trained model.

Note that such training along with filtering allows for coarse or broad granularity with respect to a specific domain. For example, in one application, a large number of general URLs may be used as the base URLs such as for general classification tasks. In another application, URLs that are in a more specific domain (such as entertainment) may be used for finer classification tasks.

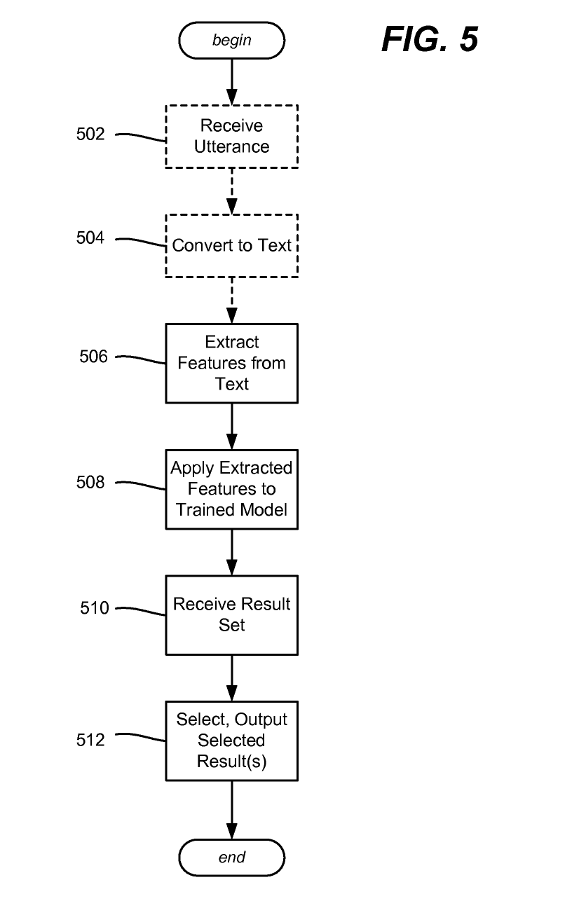

FIG. 5 represents online usage of the trained classifier, which via steps 502 and 504 may receive an utterance that is recognized as text for classification, or otherwise start with text at step 506, which represents extracting features from the text. Features may include one or more individual words, phrases, sentences, word count and other types of text-related features.

Step 508 applies the features to the trained deep learning model, which uses them to classify the text as described herein. Step 510 represents receiving the result set, which may be a single category, or more than one category, such as each category ranked by/associated with a probability or other score. Step 512 outputs the results, which may include selection of one from the set, or the top two, and so on, depending on the application.

As can be seen, a deep model is trained (e.g., a deep neural network using regular stochastic gradient descent) to learn mappings from implicitly annotated data such as queries to labels. The use of a query click log for the unsupervised training, for example, provides for feature vector-based classification. This enables word, phrase or sentence level embeddings for example, which facilitates unsupervised semantic utterance classification by using the embeddings for the name of the class. Further, regardless of input length, and even if nothing matched exactly in the training data, there is a latent semantic feature set that may be used as input to match with feature-related data in the model.

The deep model may be trained for general classification, or trained for any suitable domain for finer grained classification. In addition to classification, the model may be used for extraction tasks, language translation tasks, knowledge graph population tasks and so on.

Also described is zero-shot learning for semantic utterance classification without labels, and zero-shot discriminative embedding as a technique for feature extraction for traditional semantic utterance classification systems. Both zero-shot learning and zero-shot discriminative embedding approaches exploit unlabeled data.

There is thus described performing a semantic parsing task, including providing feature data representative of input data to a semantic parsing mechanism, in which a model used by the semantic parsing mechanism comprises a deep model trained at least in part via unsupervised learning using unlabeled data. Output received from the semantic parsing mechanism corresponds to a result of performing the semantic parsing task.

The input data may correspond to an utterance and the semantic parsing mechanism may comprise a classifier that uses the model to classify the input data into a class to generate the output. In one alternative, the input data may correspond to a class and a word, phrase and/or sentence; performing the semantic parsing task may comprises determining relationship information between the word, phrase or sentence and the class.

One or more aspects are directed towards training the model, including extracting features from a dataset. At least some of the features may be used to generate embeddings of the deep network. The unlabeled data may be obtained from one or more query click logs; training the model may include extracting features corresponding to a distribution of click rates among a set of base URLs. The set of base URLs may be selected for a specific domain. Training the model may include computing features based upon zero-shot discriminative embedding, which may comprise learning an embedding space and optimizing an entropy measure.

One or more aspects may include a classifier and associated deep network, in which the deep network is trained to have an embeddings layer corresponding to at least one of words, phrases, or sentences. The embeddings layer is learned (at least in part) from unlabeled data. The classifier is coupled to a feature extraction mechanism to receive feature data representative of input text from the feature extraction mechanism, with the classifier configured to classify the input text as a result set comprising classification data.

A speech recognizer may be used to convert an input utterance into the input text. The classifier may comprise a support vector machine, and/or may be coupled to provide the result set to a personal assistant application.

The unlabeled data may be obtained from at least one query click log. A classification layer in the deep network may be based upon continuous value features extracted from the at least one query click log, including a click rate distribution. The embeddings layer may be based upon data extracted from the query click log queries.

One or more storage media or machine logic may have executable instructions, which when executed perform steps, comprising, classifying textual input data into a class, including determining feature data representative of the textual input data, providing the feature data to a classifier, in which a model used by the classifier comprises a deep network trained at least in part on unlabeled data, and receiving a result set comprising a semantic class from the classifier. The unlabeled data may comprises query and URL click data for a set of base URLS, and a click rate distribution may be used as feature data in training. The textual input data may be converted from a spoken utterance.

### Example Computing Devices

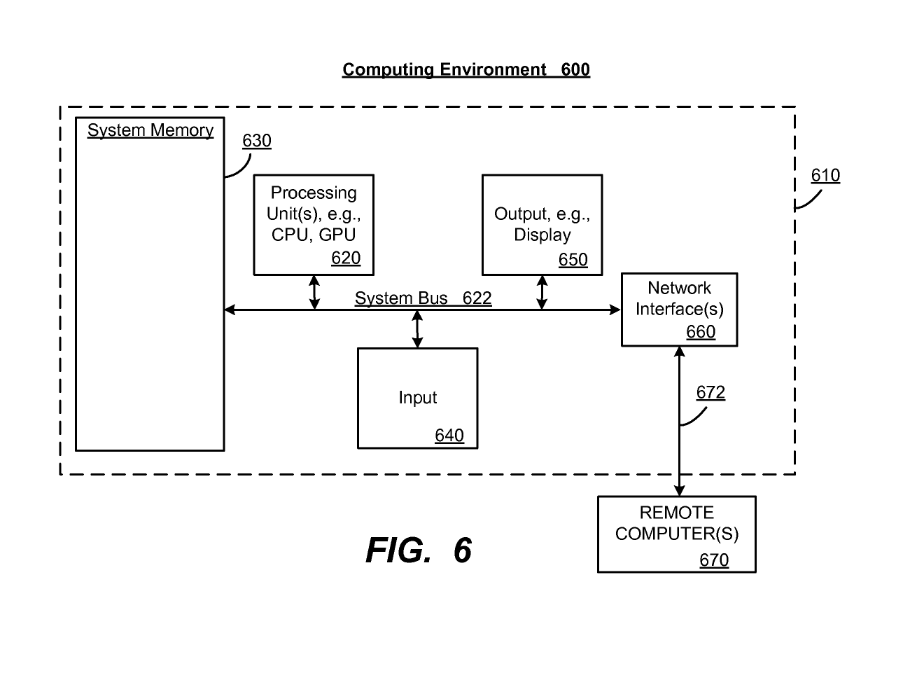

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 6 is but one example of a computing device. Such a computing device may, for example, be used to run a personal assistant application that classifies input text into a class/category.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 6 thus illustrates an example of a suitable computing system environment 600 in which one or aspects of the embodiments described herein can be implemented, although as made clear above, the computing system environment 600 is only one example of a suitable computing environment and is not intended to suggest any limitation as to scope of use or functionality. In addition, the computing system environment 600 is not intended to be interpreted as having any dependency relating to any one or combination of components illustrated in the example computing system environment 600.

With reference to FIG. 6, an example remote device for implementing one or more embodiments includes a general purpose computing device in the form of a computer 610. Components of computer 610 may include, but are not limited to, a processing unit 620, a system memory 630, and a system bus 622 that couples various system components including the system memory to the processing unit 620.

Computer 610 typically includes a variety of computer readable media and can be any available media that can be accessed by computer 610. The system memory 630 may include computer storage media in the form of volatile and/or nonvolatile memory such as read only memory (ROM) and/or random access memory (RAM). By way of example, and not limitation, system memory 630 may also include an operating system, application programs, other program modules, and program data.

A user can enter commands and information into the computer 610 through input devices 640. Input devices may include mice, keyboards, remote controls, and the like, and/or natural user interface (NUI) technology. NUI may be defined as any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Specific categories of NUI technologies on which Microsoft is working include touch sensitive displays, voice and speech recognition, intention and goal understanding, motion gesture detection using depth cameras (such as stereoscopic camera systems, infrared camera systems, rgb camera systems and combinations of these), motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods).

A monitor or other type of display device is also connected to the system bus 622 via an interface, such as output interface 650. In addition to a monitor, computers can also include other peripheral output devices such as speakers and a printer, which may be connected through output interface 650.

The computer 610 may operate in a networked or distributed environment using logical connections to one or more other remote computers, such as remote computer 670. The remote computer 670 may be a personal computer, a server, a router, a network PC, a peer device or other common network node, or any other remote media consumption or transmission device, and may include any or all of the elements described above relative to the computer 610. The logical connections depicted in FIG. 6 include a network 672, such local area network (LAN) or a wide area network (WAN), but may also include other networks/buses. Such networking environments are commonplace in homes, offices, enterprise-wide computer networks, intranets and the Internet.

As mentioned above, while example embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

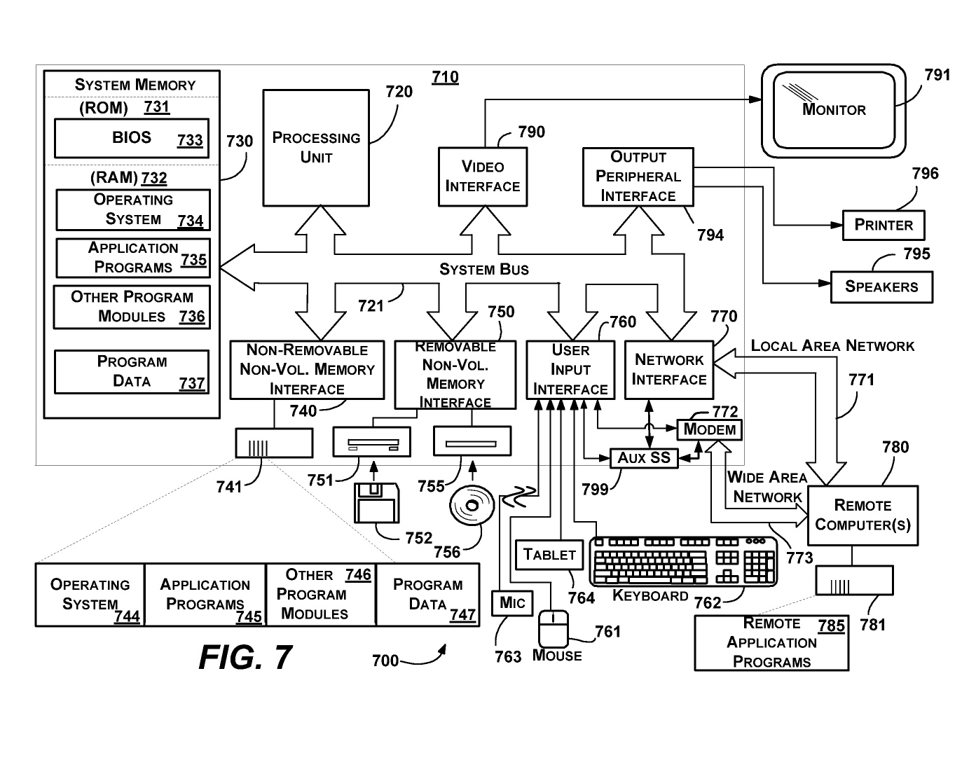

FIG. 7 illustrates an example of another suitable computing and networking environment 700 into which the examples and implementations of any of FIGS. 1-5 may be implemented, for example. For example, the computing environment 700 may be used in training a model for use by a classifier. The computing system environment 700 is only one example of a suitable computing environment and is not intended to suggest any limitation as to the scope of use or functionality of the invention. Neither should the computing environment 700 be interpreted as having any dependency or requirement relating to any one or combination of components illustrated in the example operating environment 700.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 7, an example system for implementing various aspects of the invention may include a general purpose computing device in the form of a computer 710. Components of the computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 710 typically includes a variety of computer-readable media. Computer-readable media can be any available media that can be accessed by the computer 710 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, solid-state device memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 710. Communication media typically embodies computer-readable instructions, data structures, program modules or other data. Other media may include a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736 and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the example operating environment include, but are not limited to, magnetic tape cassettes, solid-state device memory cards, digital versatile disks, digital video tape, solid-state RAM, solid-state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media, described above and illustrated in FIG. 7, provide storage of computer-readable instructions, data structures, program modules and other data for the computer 710. In FIG. 7, for example, hard disk drive 741 is illustrated as storing operating system 744, application programs 745, other program modules 746 and program data 747. Note that these components can either be the same as or different from operating system 734, application programs 735, other program modules 736, and program data 737. Operating system 744, application programs 745, other program modules 746, and program data 747 are given different numbers herein to illustrate that, at a minimum, they are different copies. A user may enter commands and information into the computer 710 through input devices such as a tablet, or electronic digitizer, 764, a microphone 763, a keyboard 762 and pointing device 761, commonly referred to as mouse, trackball or touch pad. Other input devices not shown in FIG. 7 may include a joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. The monitor 791 may also be integrated with a touch-screen panel or the like. Note that the monitor and/or touch screen panel can be physically coupled to a housing in which the computing device 710 is incorporated, such as in a tablet-type personal computer. In addition, computers such as the computing device 710 may also include other peripheral output devices such as speakers 795 and printer 796, which may be connected through an output peripheral interface 794 or the like.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include one or more local area networks (LAN) 771 and one or more wide area networks (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760 or other appropriate mechanism. A wireless networking component 774 such as comprising an interface and antenna may be coupled through a suitable device such as an access point or peer computer to a WAN or LAN. In a networked environment, program modules depicted relative to the computer 710, or portions thereof, may be stored in the remote memory storage device. By way of example, and not limitation, FIG. 7 illustrates remote application programs 785 as residing on memory device 781. It may be appreciated that the network connections shown are examples and other means of establishing a communications link between the computers may be used.

An auxiliary subsystem 799 (e.g., for auxiliary display of content) may be connected via the user interface 760 to allow data such as program content, system status and event notifications to be provided to the user, even if the main portions of the computer system are in a low power state. The auxiliary subsystem 799 may be connected to the modem 772 and/or network interface 770 to allow communication between these systems while the main processing unit 720 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. A method, comprising, performing a semantic parsing task, including providing feature data representative of input data to a semantic parsing mechanism, in which a model used by the semantic parsing mechanism comprises a deep model trained at least in part via unsupervised learning using unlabeled data, and receiving output from the semantic parsing mechanism in which the output corresponds to a result of performing the semantic parsing task.

2. The method of claim 1 wherein the input data corresponds to an utterance and wherein the semantic parsing mechanism comprises a classifier that uses the model, and further comprising classifying the input data into a class to generate the output.

3. The method of claim 1 wherein the input data corresponds to a class and at least one of a word, phrase or sentence, and wherein performing the semantic parsing task comprises determining relationship information between the class at least one of the word, phrase or sentence.

4. The method of claim 1 further comprising, training the model, including extracting features from a dataset.

5. The method of claim 4 wherein the model comprises a deep network, and further comprising using at least some of the features to generate embeddings of the deep network.

6. The method of claim 1 wherein the unlabeled data is obtained from one or more query click logs, and further comprising, training the model, including extracting features corresponding to a distribution of click rates among a set of base Uniform Resource Locators (URLs).

7. The method of claim 6 further comprising, selecting the set of base URLs for a specific domain.

8. The method of claim 1 further comprising, training the model, including computing features based upon zero-shot discriminative embedding.

9. The method of claim 8 wherein computing the features based upon zero-shot discriminative embedding comprising learning an embedding space and optimizing an entropy measure.

10. A system comprising, a classifier and associated deep network, the deep network trained to have an embeddings layer corresponding to at least one of words, phrases, or sentences, the embeddings layer learned at least in part from unlabeled data, the classifier coupled to a feature extraction mechanism to receive feature data representative of input text from the feature extraction mechanism, and the classifier configured to classify the input text as a result set comprising classification data.

11. The system of claim 10 further comprising a speech recognizer that converts an input utterance into the input text.

12. The system of claim 10 wherein the unlabeled data is obtained from at least one query click log.

13. The system of claim 12 wherein a classification layer in the deep network is based upon continuous value features extracted from the at least one query click log, including a click rate distribution.

14. The system of claim 12 wherein the embeddings layer is based upon data extracted from queries in the at least one query click log.

15. The system of claim 10 wherein the classifier comprises a support vector machine.

16. The system of claim 10 wherein the classifier is coupled to provide the result set to a personal assistant application.

17. One or more computer-readable storage devices or machine logic having executable instructions, which when executed perform steps, comprising, classifying textual input data into a class, including determining feature data representative of the textual input data, providing the feature data to a classifier, in which a model used by the classifier comprises a deep network trained at least in part on unlabeled data, and receiving a result set comprising a semantic class from the classifier.

18. The one or more storage devices or machine logic of claim 17 wherein the unlabeled data comprises query and URL click data for a set of base URLS, and further comprising, using a click rate distribution as feature data in training.

19. The one or more computer-readable storage devices or machine logic of claim 17 having further instructions comprises receiving the textual input data as converted from a spoken utterance.

20. The one or more computer-readable storage devices or machine logic of claim 17 further comprising, training the model, including computing features based upon zero-shot discriminative embedding.
